(19) United States
(12) Patent Application Publication
(10) Pub. No.: US 2023/0356242 A1
(43) Pub. Date: Nov. 9, 2023

(54) ROTARY ATOMIZER HAVING POROUS GAS BEARINGS

(71) Applicant: DEDERT CORPORATION, Homewood, IL (US)

(72) Inventors: CLAUDE BAZERGUI, Pointe-Claire (CA); Vishal A. Wadhvani, Chicago, IL (US)

(21) Appl. No.: 17/992,578

(22) Filed: Nov. 22, 2022

Related U.S. Application Data
(60) Provisional application No. 63/338,507, filed on May 5, 2022.

(51) Int. Cl. B05B 3/10; F16C 32/06

(52) U.S. Cl. CPC B05B 3/1035; F16C 32/0618; B05B 3/1021

(57) ABSTRACT

A rotary atomizer comprises an electric motor having a stator and a rotor, a vertical shaft, one or more porous gas bearings configured to provide frictionless radial and axial support to the shaft, and a rotating disc installed at a lower end of the shaft, said rotating disc configured to spray liquid into the form of fine particles. A gap detection system monitors a distance between the porous gas bearings and the vertical shaft. Bushings on the motor housing help to maintain precise alignment of the rotor during installation and maintenance.

### CROSS-REFERENCE TO RELATED APPLICATIONS

This application claims priority to U.S. Provisional Application Ser. No. 63/338,507, filed May 5, 2022, the entire contents of which are hereby incorporated by reference in their entirety.

### TECHNICAL FIELD

The present invention relates generally to rotary disc atomizers for use in spray dryers or congealers, and more specifically to rotary atomizers having porous gas bearings.

### BACKGROUND

Spray drying is a method of producing dry powder/particles from a slurry or solution liquid by rapidly drying the liquid with a hot gas stream. Spray drying is the preferred method of drying many thermally sensitive materials such as foods and pharmaceuticals. A consistent particle size distribution is a reason for spray drying some industrial products, such as catalysts and other chemicals. Typically, air is the heated drying medium; however, nitrogen may be used if the liquid being atomized is a flammable solvent (e.g., ethanol) or if the product is oxygen-sensitive.

Generally speaking, spray dryers use an atomizer to disperse a liquid into a controlled-drop-size spray. Common types of atomizers used in spray drying include rotary disc and single-fluid pressure swirl nozzles. Alternatively, for some applications, two-fluid or ultrasonic nozzles may be used. Depending on the process and/or product needs, drop sizes from 10 to 500 micrometers may be achieved with the appropriate choices. However, common applications are often in the 100 to 200 micrometer diameter range.

### SUMMARY OF THE INVENTION

The present application discloses a system and method for improving rotary atomizer function and efficiency, with reduced maintenance and repair costs.

According to a first aspect of the present invention, a rotary atomizer comprises an electric motor having a stator and a permanent magnet rotor enabled to output a rotating force; a shaft vertically installed and having a desired length, the shaft capable of being rotated by the rotating force; one or more porous gas bearings for enabling frictionless radial and axial support of the shaft; and a rotating disc installed at a lower end of the shaft for spraying liquid in the form of fine droplets.

According to a second aspect of the present invention, a method for atomizing slurry material comprises feeding slurry material to a rotary atomizer, wherein the rotary atomizer comprises an electric motor enabled to rotate a shaft at a certain speed; using the rotary atomizer to output the liquid material in the form of atomized droplets; and circulating the atomized droplets with process gas to produce substantially dry particles.

### DESCRIPTION OF THE DRAWINGS

These and other advantages of the present invention will be readily understood with reference to the following specifications and attached drawings wherein:

FIG. 1 is a perspective view of a rotary atomizer according to the present invention.

FIG. 2 is a cutaway side view of a rotary atomizer according to the present invention showing gas passages inside the machine;

FIG. 3 is a cutaway side view of a rotary atomizer according to the present invention showing gas supply bushings feeding the radial pads;

FIG. 4 is a cutaway side view of a rotary atomizer according to the present invention further describing the porous gas bearing components of the invention;

FIG. 5 is a cutaway side view of a rotary atomizer according to the present invention further describing the gap detection embodiments of the invention.

FIG. 6 is an enhanced view of callout A from FIG. 5 showing the mechanic resistance temperature detector.

FIG. 7 is an enhanced view of callout B from FIG. 5 showing the mechanical springs touching the thrust bearing pad.

### DETAILED DESCRIPTION

Preferred embodiments of the present invention will be described hereinbelow with reference to the accompanying drawings. In the following description, well-known functions or constructions are not described in detail because they may obscure the invention in unnecessary detail.

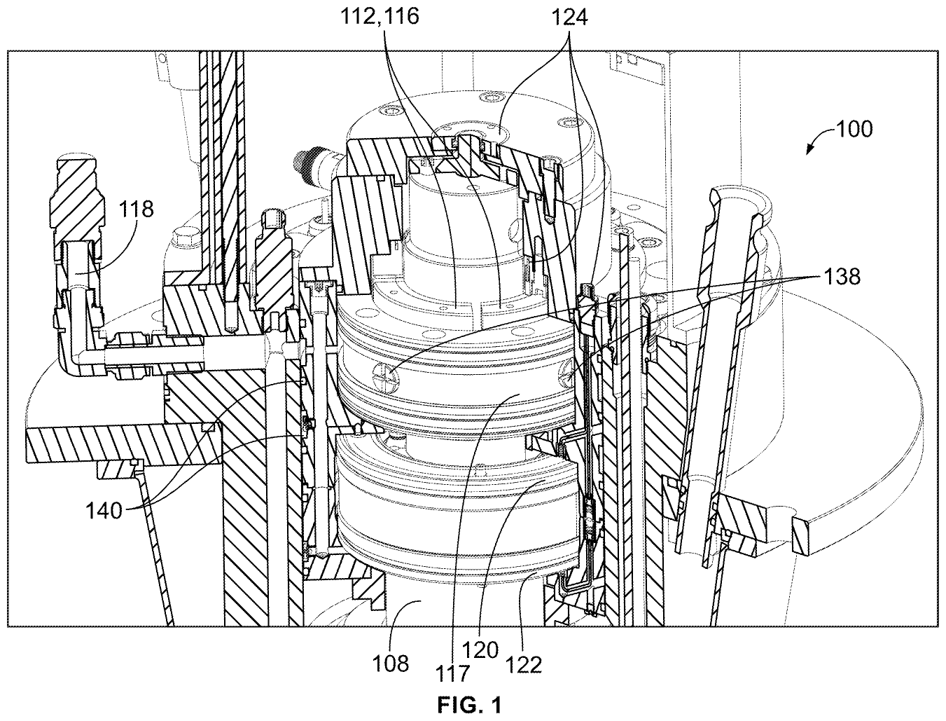

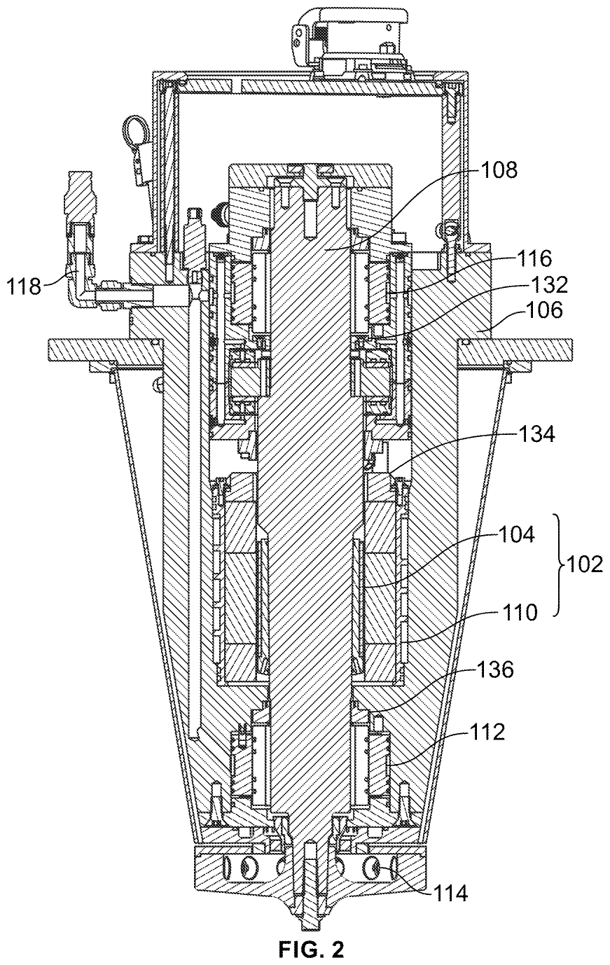

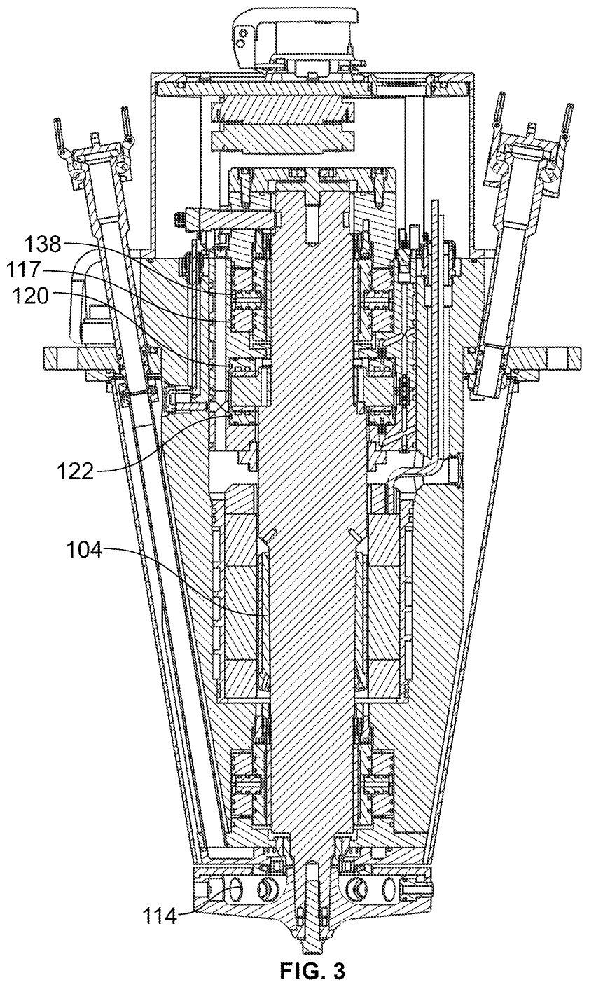

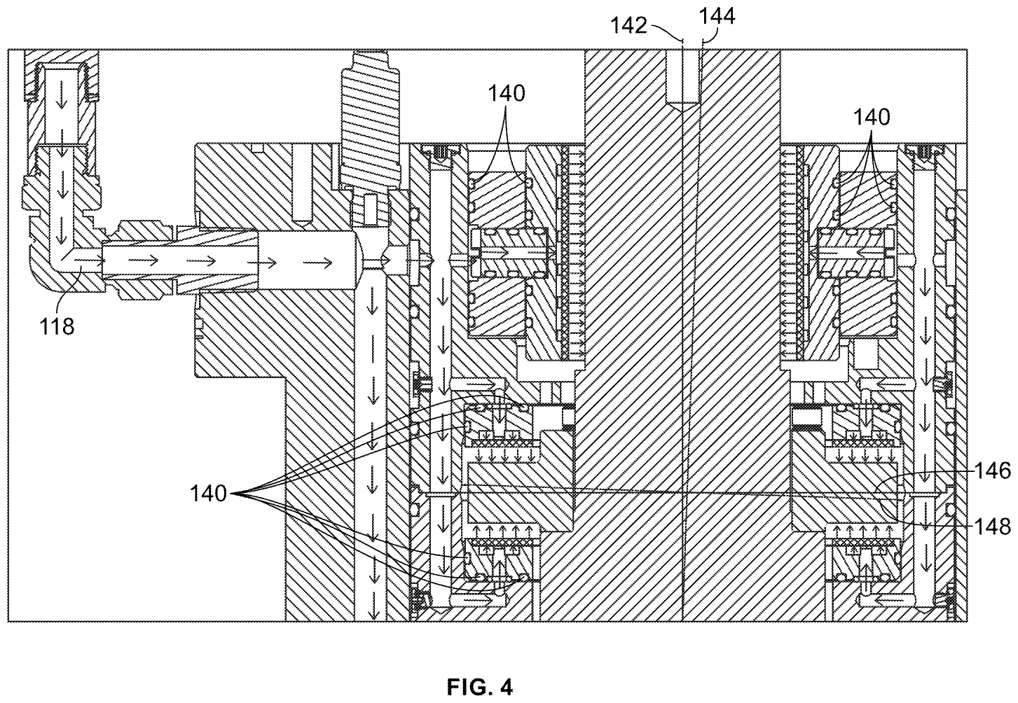

FIGS. 1-7 illustrate an exemplary rotary atomizer system 100 having improved reliability and enabled to yield increased RPM and disc speed. Rather than employing an induction rotor, such as those used in most existing rotary atomizer systems, the rotary atomizer system uses an electric motor 102 having a permanent magnet rotor 104, resulting in a more efficient motor requiring less physical space for a given power output. The electric motor 102, which receives power via a power electrical receptacle, generally comprises a motor housing 106, permanent magnet rotor 104, a stator 110, and a shaft 108. A smaller motor size typically allows for closer proximity of the disc to the lower radial bearing assembly 112. The motor 102 is preferably constructed with stainless steel which is both resistant to corrosion and a good dissipater of heat. Other materials such as aluminum, or other metals are envisioned. As a result of the ability to have closer proximity, a motor 102 can operate throughout its speed range while remaining below the first critical speed of the shaft 108. Rotating shafts, even in the absence of an external load, can deflect during rotation as shown in FIG. 4. The combined weight of a shaft 108 and disc 114 can cause deflection that often creates resonant vibration above a certain speed, known as the critical speed. Thus, to function properly, the motor 102 should be operated at speeds less than the critical speed. Also, this motor configuration permits use of a smaller disc diameter, which is generally less costly and easier to manipulate, leaving sufficient room around the motor for the placement of the liquid feed tube(s).

A permanent magnet rotor 104 provides numerous advantages over its AC equivalents (e.g., induction or asynchronous motors). For instance, permanent magnet rotors 104 generally yield a higher speed and higher torque output, while increasing power efficiency by eliminating the need for unnecessary current that would otherwise flow through the rotor windings of traditional induction motors. Another benefit attributed to the use of permanent magnet rotors 104 is increased power density (i.e., the power that may be extracted from a given space). Generally speaking, a permanent magnet motor 102 typically produces as much as 30% to 40% more power density than a conventional and similar-sized AC asynchronous motor. An increase in power density provides the opportunity to increase performance without requiring additional space for a larger motor or, alternatively, to reduce the motor size and weight while maintaining the original performance. Decreasing motor power size and consumption can lead to lower operating temperatures, thus reducing the efforts needed to cool the motor and/or motor system. The permanent magnet rotor 104 of the said embodiment has a conical interference fit with the shaft 108 for ease of maintenance and rebuilding.

The rotary atomizer system 100 may further employ one or more porous gas bearings including upper radial bearing assembly 116 and lower radial bearing assembly 112, which may be supported by one or more upper/lower bearing housings to enable frictionless support of the shaft 108, rotor 104, and disc 114. However, in certain embodiments, bearing housings may not be necessary. For example, a single housing may encompass both bearings and a stator 110. A benefit of the porous gas bearings 112 and 116 is that they are contactless and thus do not require lubrication or speed restrictions on the electric motor. The porous gas bearings 112 and 116 may also provide both primary radial and axial support for the shaft 108, rotor 104, and disc 114. Therefore, the atomizer system 100 of the present invention is able to operate at higher RPM to yield increased disc speeds. Moreover, the segmented porous gas bearings 112 and 116 of the present invention offer several advantages over known systems including, but not limited to providing a passive system that requires only gas pressure, requiring a smaller housing, bigger shaft diameter, producing higher loads, eliminating the need for backup bearings, allowing for thermal radial shaft expansion, allowing for uniform gas loads throughout contact surface.

In certain embodiments, the porous gas bearings 112 and 116 are radial bearings mounted in a cartridge 117 with a common gas supply 118. The advantages of a common gas supply 118 include reduced complexity of running gas supply to individual pads, reduction of the number of points of failure due to loss of gas supply, among others. In some embodiments, the gas supplied to the bearings can come from compressed process gas associated with the operation of the rotary atomizer. In other embodiments, the gas supply can comprise a specific gas (e.g., nitrogen) or combination of gases.

In some embodiments, the porous gas bearings 116 and 118 comprise graphite, which is porous in its natural form, bonded to a stainless steel housing. In other embodiments, the porous gas bearings comprise other naturally porous material, composite materials having porous structures, or bearing-type material having a multitude of discreet machined holes with desired porosity characteristics.

In some embodiments, the rotary atomizer 100 further comprises a configuration of porous gas bearings including upper thrust bearing 120 and lower thrust bearing 122 located radially to the shaft 108 such that the porous gas bearings form a non-continuous surface covering the entirety of the rotating shaft (e.g., so as to form slots, grooves, holes, or other gapping). In other embodiments, the porous gas bearings 120 and 122 are configured axially to the shaft 108 in a manner that provides either a continuous or non-continuous surface covering a portion of the rotating shaft 108 (e.g., so as to form slots, grooves, holes, or other gapping). In some embodiments, the porous gas bearings 120 and 122 are configured axially to a collar portion of the shaft. While not being bound to one particular theory, the present invention allows for a configuration of porous gas bearings 120 and 122 proximal to the rotating shaft that allows for heat dissipation and improvement of atomizer performance characteristics.

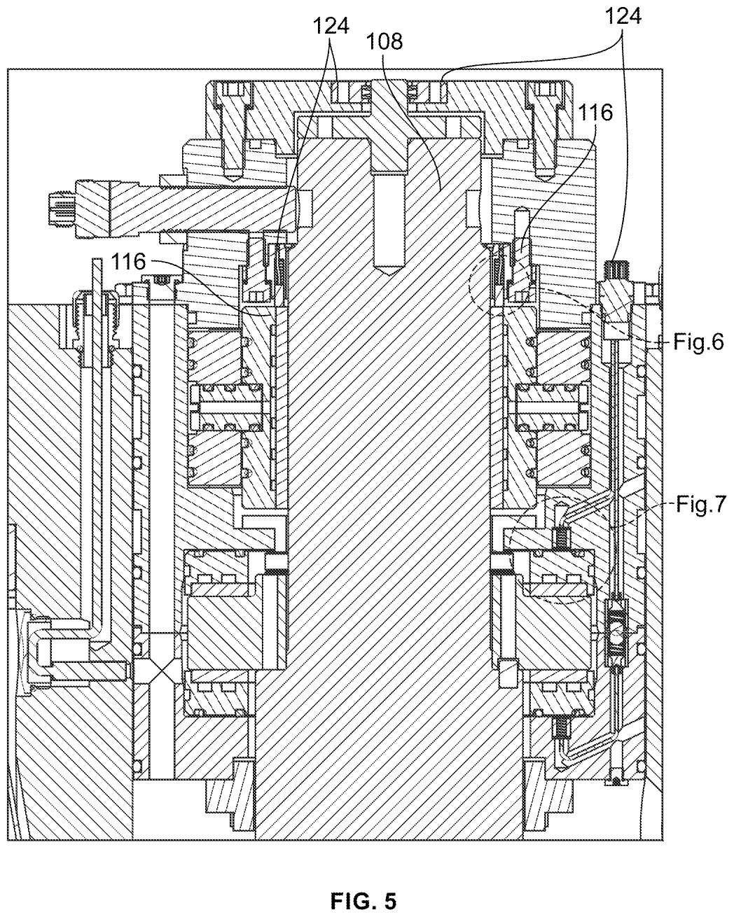

In certain embodiments, the rotary atomizer 100 of the present invention comprises a gap detection system 124 that monitors one or more parameters associated with bearing health and performance as depicted in FIG. 5. For example, in one embodiment, the gap detection system 124 comprises components that measure a resistance associated with the distance between the upper radial bearing assembly 116 and the rotating shaft 108, whereby the gap detection system 124 will shut down the operation of rotary atomizer 100 upon reaching or exceeding a resistance threshold. For example, in some embodiments, a current source is supplied to the rotating shaft 108 via a grounding ring, one or more of the porous gas bearings 114 or 116 are electrically connected to a panel-mounted programmable logic controller (PLC), which monitors if the supply current bridges to the gas bearing pad 120 or 122. As depicted in FIG. 7, a mechanical spring 132 touching the thrust pad along with an electrical wire 134 may form a leg of the electrical resistance circuit used to detect whether the shaft 108 contacts lower thrust bearing 122 or upper thrust bearing 120.

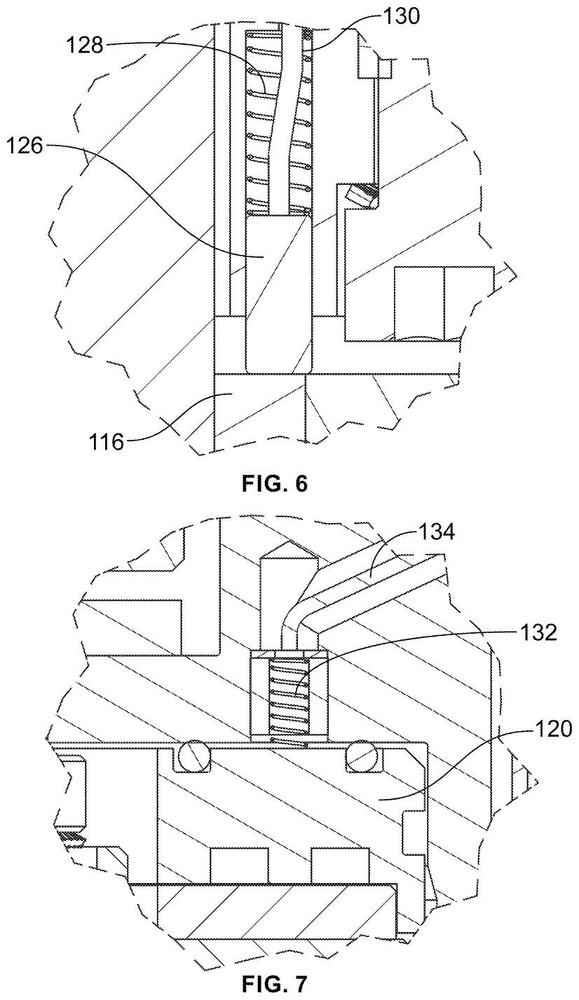

In another embodiment, the gap detection system 124 comprises components that measure a temperature of the bearing pads 114 or 116 either by an infrared sensor or a spring-loaded contact temperature sensor, whereby the gap detection system will shut down the operation of rotary atomizer 100 if a temperature threshold is reached or exceeded. For example, as depicted in FIG. 6, a metallic resistance temperature detector (RTD) 126 is pushed via a spring 128 and touches the radial bearing pad along with an electrical wire 130. If the temperature detected by RTD 126 exceeds a predetermined threshold, rotation of the shaft 108 is stopped by gap detection system 124.

The gap detection system 124 provides several benefits, including minimizing the total down time on the machine due to repairs that may be required if the rotary atomizers 100 operates in hazardous conditions that would cause damage to the systems and components therein. Additional benefits of the gap detection system 124 include longer life of the internal components, increased reliability of the system, and others. In some embodiments, a resistance level is determined where there is contact between the shaft and the porous gas bearings and a resistance threshold level is determined to indicate the relative distance between the shaft and the PGBs when is no contact between them. While not being bound to one particular theory, the resistance threshold level can provide information regarding the operation of the atomizer 100. This information can be used to prevent operation of the atomizer 100 when a certain resistance threshold is reached or a percentage thereof (e.g., shut down when 75% of resistance threshold is reached).

In some embodiments, due to the magnetic attraction of the rotor 104 to the metal stator laminations, the rotary atomizer 100 of the present invention comprises integral guide bushings including upper shaft guide bushing 132, rotor guide bushing 134, and lower shaft guide bushing 136 located radially to the shaft 108 and rotor 104 that enable efficient replacement of the porous gas bearings 112 and 116 without the need of shaft alignment tooling. Additional benefits of the integral guide bushings 132, 134, and 136 include guiding shaft assembly during initial install/assembly without the need of any elaborate/additional tooling, thereby reducing the resources needed to maintain and repair the rotary atomizer 100.

The use of porous gas bearings 112 and 116 in the present invention achieves several efficiencies and advantages of other known rotary atomizers. For example, unlike atomizers using magnetic bearings, the atomizer of the present invention does not require the use of friction back-up bearings. Similarly, the porous gas bearings 112 and 116 used in the atomizer of the present invention do not require the intensive magnetic tuning required for different disc designs to be used with various magnetic bearing rotary atomizer embodiments. The porous gas bearings 112 and 116 further improve the operation of the rotary atomizer 100, including withstanding higher imbalance forces on the disc 114, increased radial load capacity, and increased shaft size. The design of the gas bearings 112 and 116 is such that, along with the guide bushings 132, 134, and 136, it prevents any damage to the atomizer internals (motor, shaft etc.) in the event of a gas pressure loss i.e. loss of bearing mechanism and helps rapid spin-down of the machine due to the braking action since they rub against the rotating shaft 108.

In one embodiment of the invention depicted in FIG. 4, the porous gas bearings 112 and 116 are configured in one or more segments located radially along the shaft 108. The segment(s) bearings are configured with a central gas supply bushing 138 in a cartridge 117. In other embodiments, the porous gas bearing segment(s) are radially positioned within a cartridge 117 on gaskets 140 (e.g., O-ring), configured to allow the cartridge 117 (and thereby the porous gas bearings) to move dynamically in response to operating conditions to maintain a desired distance between the shaft 108 and porous gas bearings 112 and 116. The gaskets 140 act in combination as springs in series and parallel to comply with the deflection of shaft 108. This allows the rotary atomizer to continue to operate even when shaft 108 is slightly deflected. As shown, centerline 142 depicts the rotation axis of shaft 108 during normal operation and centerline 144 depicts the rotation axis of shaft 108 under deflection. Centerlines 146 and 148 show the deflection of the shaft collar under normal operation and under deflection, respectively. The arrangements of the gaskets 140 in series and parallel allows for the deflection of the shaft 108 and the shaft collar without requiring shutdown of rotary atomizer system 100.

In other embodiments, the lower radial bearing assembly 112 and upper radial bearing assembly 116 are also mounted on gaskets 140 configured to provide additional dynamic response to operating conditions to maintain a desired distance between the shaft 108 and the porous gas bearings 112 and 116. While not being bound to one particular theory, the porous gas bearings 112 and 116, cartridges 117, and gaskets 140, along with other atomizer components function to provide a dynamic response to changes in the shaft position that may occur during operation of the atomizer 100 including, but not limited to, radial movement during upset or imbalance disc loading, higher vibrational loads, and thermal expansion of the rotating shaft. The gaskets 140 can be compressed or expanded to accommodate changes in shaft position compared to centerline under normal operation.

For example, during typical operation of a rotary atomizer 100 of the present invention, there can exist disc imbalance as a result of variable loads on the disc 114, which in turn result in shaft movement (e.g., vibration, deflection, etc.). While not being bound to one particular theory, the atomizer 100 of the present invention provides for an increased balancing tolerance. The combination of the gap detection system 124 and porous gas bearings configured to provide a dynamic response to changes in shaft positioning allow the atomizer 100 of the present invention to maintain a desired distance between the shaft 108 and the bearing pads 112 and 116 which results in decreased wear and degradation, thereby prolonging the longevity of both the porous gas bearings 112 and 116 and the other component parts of the atomizer 100.

Using a permanent magnet rotor 104 in conjunction with porous gas bearings 112 and 116 permits the atomizer 100 to reach greater and more favorable operating RPM speeds, thereby increasing spray drying efficiency while also reducing maintenance. A favorable operating speed (RPM) will vary depending on the size of the disc 114. Accordingly, discs 114 are available in a plurality of sizes; however, smaller disc sizes may be preferable because they are generally less expensive and easier to manipulate. In some embodiments, the atomizer 100 of the present invention is configured to provide a target peripheral disc tip speed that can be adjusted based on the application. For example, for certain applications, a high peripheral disc tip speed is necessary e.g., 985 ft/sec (300 m/s). Without being bound to one particular theory, the atomizer 100 of the present invention is configured to maintain a peripheral disc tip speed for longer operational periods due to one or more factors associated with the porous gas bearings 112 and 116, the gap detection system 124, and/or combinations thereof.

Although various embodiments have been described with reference to a particular arrangement of parts, features, and the like, these are not intended to exhaust all possible arrangements or features, and indeed many other embodiments, modifications, and variations will be ascertainable to those of skill in the art. Thus, it is to be understood that the invention may be practiced otherwise than as specifically described above. The above-cited patents and patent publications are hereby incorporated by reference in their entirety herein, because they provide additional background information, which may be considered relevant to the present application.

What is claimed is:

1. A rotary atomizer comprising:
an electric motor having a stator and a rotor;
a vertical shaft;
one or more porous gas bearings configured to provide frictionless radial and axial support to the shaft; and
a rotating disc installed at a lower end of the shaft, said rotating disc configured to spray liquid into the form of fine particles.

2. The rotary atomizer of claim 1, further comprising:
guide bushings located radially to the shaft.

3. The rotary atomizer of claim 1, further comprising:
a cartridge having a common gas supply configured to provide gas to the one or more porous gas bearings.

4. The rotary atomizer of claim 3, wherein the cartridge further comprises one or more gaskets configured to allow the porous gas bearings to maintain a gap between the porous gas bearings and the vertical shaft in response to movement of the vertical shaft during operation of the rotary atomizer.

5. The rotary atomizer of claim 3, wherein the porous gas bearings further comprises one or more gaskets configured to allow the porous gas bearings to maintain a gap between the porous gas bearings and the vertical shaft in response to movement of the vertical shaft during operation of the rotary atomizer.

6. The rotary atomizer of claim 1, further comprising:
a gap detection system configured to monitor one or more parameters associated with a distance between the porous gas bearings and the vertical shaft.

7. The rotary atomizer of claim 6, wherein the gap detection system monitors the temperature of one or more porous gas bearings.

8. The rotary atomizer of claim 6, wherein the gap detection system monitors a resistance level associated with the distance between the porous gas bearings and the rotating vertical shaft during operation of the rotary atomizer.

9. The rotary atomizer of claim 1, further comprising a housing configured to align the one or more porous gas bearings with the stator.
